(19) United States
(12) Patent Application Publication
(10) Pub. No.: US 2005/0279953 A1
(43) Pub. Date: Dec. 22, 2005

(54) Heliostat alignment system

(76) Inventor: Leo Gerst, Lindenwold, NJ (US)

Correspondence Address: COLESANTI & ASSOCIATES LLC, Suite 1505, 117 North 15th Street, Philadelphia, PA, 19102, US

(21) Appl. No.: 10/871,418

(22) Filed: Jun. 18, 2004

(51) Int. Cl. G01N 21/86

(52) U.S. Cl. 250/548

(57) ABSTRACT

A heliostat comprising a linear actuator to control the panning movement of its mirror, the heliostat is mounted on a pedestal. One end of said linear actuator that controls the panning movement will mount on a control arm that is extending off the stationary part of the pedestal. The other end of said linear actuator will mount on the panning part of the pedestal. This invention also allows for a means to indicate when the heliostats alignment apparatus is out of align. A means to automatically realign the alignment apparatus, by using the radiant energy that is reflected back off the target, which is compared to the targets background, which could be the sky. A means to indicate when the mirror is not lined up with its alignment apparatus.

### FIELD OF THE INVENTION

An improved heliostat comprising a linear actuator to control the panning movement of its mirror, the heliostat is mounted on a pedestal. One end of said linear actuator that controls the panning movement will mount on a control arm that is extending off the stationary part of the pedestal. The other end of said linear actuator will mount on the panning part of the pedestal. This invention also allows for a means to indicate when the heliostats alignment apparatus is out of align. A means to automatically realign the alignment apparatus, by using the radiant energy that is reflected back off the target, which is compared to the targets background, which could be the sky. A means to indicate when the mirror is not lined up with its alignment apparatus.

### BACKGROUND OF THE INVENTION

The sun radiates about 1,000 watts of energy per square meter. The problem with the suns radiant energy is that it is diffuse. One method of collecting the suns radiant energy is to use a heliostat. To use a heliostat to collect solar energy, a plurality of heliostats are usually needed. The number of heliostats needed would depend upon the amount of solar energy required for its task, along with the mirror area of each heliostat used.

The only purpose of the heliostat is to reflect the suns energy to a fixed target. When a heliostat is used to collect the suns energy for experimental test purposes, one of the main tasks of the experiment is to design and implement a field of heliostats. The reason for this is that there are no off the shelf heliostats available that are reliable, inexpensive and accurate.

There are two ways to align the mirror of the heliostat to its target, the first is with a computer that controls the mirror without an alignment apparatus. The computer knowing the target's locale, where the sun will be, and the mirrors exact position, will move the mirror into alignment with its target. The problems with the computer based alignment systems are knowing the mirrors exact position, also it is not cost effective to make smaller heliostat. This design is also typically expensive, due to the computer and its software and the heliostats need for a rigid structure. The other means of aligning the heliostats mirror to its target is to use an alignment apparatus, typically this alignment apparatus is placed inline with the mirror and the target. As the sun reflects off the mirror it will cast a shadow onto the alignment apparatus. This shadow is used to align the mirror to its target. Photo sensors on the alignment apparatus are used to sense when the mirror is out of alignment with its target. It will then feed this information to a microprocessor, which controls the mirror's pan and tilt movement with motors. As the mirror is moved back into realignment with its target, the alignment apparatus will sense this and will then feed this information to the microprocessor. The main problem with aligning a heliostat with an alignment apparatus is in keeping the alignment apparatus pointing at or inline with its target.

By using an alignment apparatus to align the mirror of a heliostat to its target, knowing the mirrors exact position is not needed. Since the exact position of the mirror is not needed, the heliostat can be made of material that is less rigid and therefore less expensive.

Central control over a field of heliostats may be more important when smaller heliostats are used due to the increased number of heliostats needed. Central control over the field of heliostats could be used to reposition the mirror in case of high wind. Also information from the heliostats could be sent to central control, to indicate alignment apparatus or mirror out of alignment.

The heliostat mirror needs to move on two axes, known as azimuth and elevation, or also commonly known as pan and tilt respectively.

Prior Art U.S. Pat. No. 6,231,197 uses concave mirrors to reflect the suns energy to its target. The reason for concave mirrors is so when the suns radiant energy hits its target it will be concentrated, allowing for heliostats that are larger than its target. The disadvantage is the cost of using concave mirrors. When using a flat mirror the target needs to be larger than the heliostat. The greater the distance the heliostat is from its target, the larger the need for using smaller heliostats.

The cost of using heliostats for the utilization of the suns energy would be its installation and maintenance cost. The cost needs to be further broken down to its cost per square meter of heliostat mirror. The size, design, number and alignment method of the heliostat used for its task is not as important as its installation and maintenance cost per square meter of heliostat mirror. Cost per sq meter of heliostat mirror is important because without it the ability to know if a field of heliostats could be used to collect the suns radiant energy at a cost that is in line with other means of energy production would be difficult.

### SUMMARY OF THE INVENTION

Prior art showed many different ways for the mechanical movement for the mirror of a heliostat. Prior art also showed ways of controlling or aligning the mirror of the heliostat to its target. It is the object of this invention to provide a novel heliostat system with a cost per square meter of heliostat mirror that is less then prior art and any heliostat in use today. This invention does this by utilizing smaller heliostats, by allowing for lower maintenance costs due to the alignment used in this invention. By addressing both the alignment and movement of the mirror as a system, this invention allows for a lower cost per square meter of heliostat mirror, do to the novel alignment and mechanical movement of the mirror, which allows for a non-rigid structure of the heliostat.

An object of the present invention is to provide a novel heliostat system including an improved structure for the movement of the mirror to the target by using linear actuators for both the panning and tilting movement of the mirror.

The pedestal on which the mirror of the heliostat sits needs to have a means to move the mirror two ways; a panning and tilting movement. On the top of the pedestal there will be a point, which will need to rotate. This rotating movement will give the mirror its panning movement, which can be known as the panning portion of the pedestal. The mirror will be attached to the panning portion and will be pivotally mounted. A control arm will be horizontally mounted to the panning portion; two nuts will be pivotally mounted to this control arm, the threaded portion of the linear actuators will move through the nuts. A linear actuator will be pivotally mounted on the mirror and will be used to tilt the mirror. On the stationary portion of the pedestal, a linear actuator will be pivotally mounted to a control arm and will be used to pan the mirror.

Said linear actuators are stepping motors, this will allow for over 40,000 steps of alignment to the pan and tilt movement of the mirror. This provides a high degree of accuracy.

By using a single linear actuator to pan the mirror, the mirror will typically not be able to rotate more then 180 degrees. This is the main reason why prior designs do not use a linear actuator to pan the mirror. Prior art U.S. Pat. No. 6,440,019 uses a sprocket in the shaft of the pedestal to pan the mirror. Prior art U.S. Pat. No. 6,123,067 uses two hydraulic actuators to rotate the azimuth platform assembly. Both of the prior art designs will rotate more then a 180 degrees, and are of a rigid structure. The advantage of using a single linear actuator to pan the mirror is the non-rigid structure of the heliostat and the way the alignment apparatus works in tangent with the linear actuators. A single linear actuator could rotate a heliostat more then a 180 degrees if the threaded portion of the linear actuator is flexible.

The mirror of the heliostat will never reflect 100 percent of its surface area to the target. This is due to the fact that the sun is reflected off the mirror to the target. The mirror will always be on an angle with respect to the sun. As the angle increases, the energy to the target is reduced. The additional energy that can be delivered to the target for heliostats that can pan more then 180 degrees is minimal.

It is also the object of the invention to provide a novel heliostat system that's alignment apparatus will sense when it is out of alignment and indicate that it is out of alignment, and also realign itself back inline with the target, this will reduce misalignment of the alignment apparatus.

The means by which this invention aligns the heliostat's mirror to its target is an alignment apparatus, which is mounted on a pedestal placed inline with the mirror and target. The alignment apparatus feeds a micro-controller, which will control the movement of the linear actuators. This alignment apparatus provides a novel means for realigning itself back to the target. A photo sensor will be mounted on the alignment apparatus; this sensor will be focused on the target. When the alignment apparatus is not lined up with the target, the photo sensor will realign the alignment apparatus by way of two small motors. The realignment can be helped by way of central control. It will also indicate when it is out of alignment, with visual indicators on the alignment apparatus as well as reporting to central control. The targets radiant energy will be different then its background, the background being the sky.

It is also the object of the invention to provide a novel heliostat system that's alignment apparatus can indicate when the mirror is out of alignment with the alignment apparatus.

A second photo sensor will be mounted on the alignment apparatus, which will be used to indicate when the mirror is out of alignment with the alignment apparatus. This photo sensor will be focused on the reflection of the sun off of the mirror. If the mirror is not aligning the sun to the target through the alignment apparatus, the photo sensor will sense this and indicate by way of visual indication on the alignment apparatus and reporting to central control.

This invention also allows for independent operation of the heliostat where by no central control is needed.

According to one inventive, the heliostat assembly includes a heliostat mirror and first and second control arms connected to the mirror for aligning the mirror relative to a target, and first and second linear actuators operatively connected to the first and second control arms, respectively, for aligning the mirror relative to a target. The first control arm provides panning of the mirror and second control arm provides tilting of mirror. A feedback control loop circuit may be used to realign the mirror.

According to another inventive aspect, a heliostat assembly and alignment assembly are provided in combination, the heliostat assembly including a heliostat mirror, and at least one actuator for aligning the mirror relative to a target; the alignment assembly including a photosensor to detect light from a target, and at least one actuator for aligning the alignment assembly relative to the target.

Another inventive aspect resides in a method for aligning a heliostat mirror to its target including the steps of: sensing the light reflected off the target using a photo sensor mounted to an alignment apparatus; and realigning the alignment apparatus with the target in response to the signals from the photosensor.

### BRIEF DESCRIPTION OF THE DRAWINGS

Other aspects, advantages and novel features of the invention will become more apparent from the following detailed description of the invention when considered in conjunction with the accompanying drawings wherein:

FIG. 1 is an overall perspective view of the heliostat;

FIG. 2 is a side view of the alignment apparatus; and

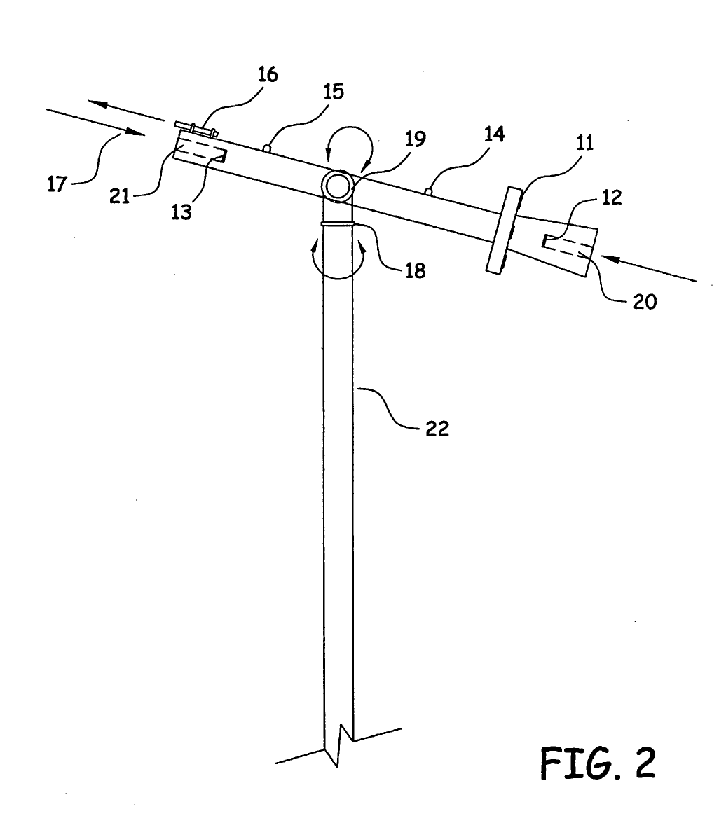

FIG. 3 illustrates a preferred embodiment of the pan and tilt assembly.

### DETAILED DESCRIPTION

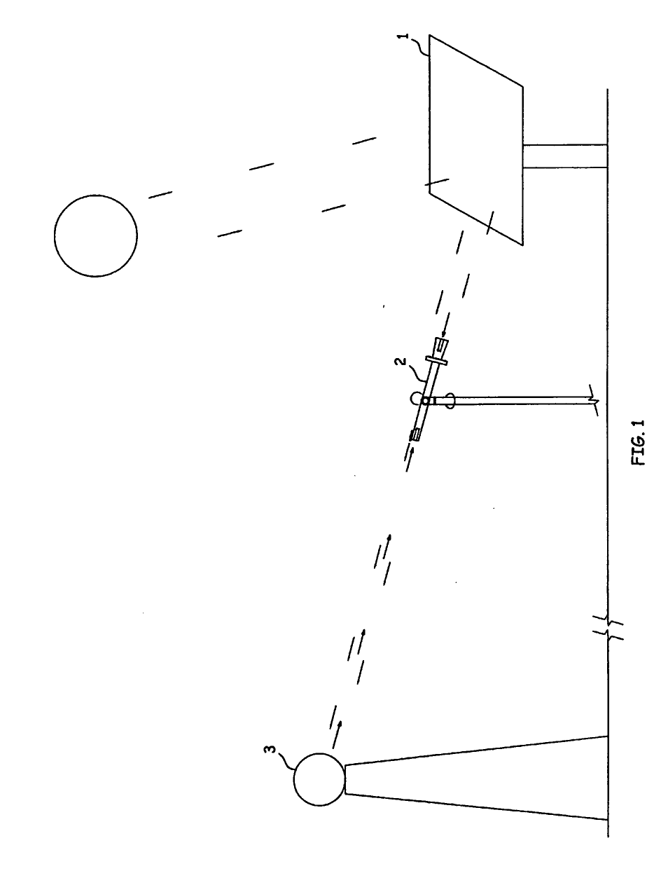

FIG. 1 is an overview of the heliostat. The (2) alignment apparatus is placed in between the (1) mirror and the (3) target. As the rays from the sun hit the (1) mirror the reflection of the sun off the (1) mirror will hit the (2) alignment apparatus, which will cast shadows on the front of the (2) alignment apparatus. The front of the (2) alignment apparatus will be the end that is facing the (1) mirror and the rear of the (2) alignment apparatus will be the end facing the target. As the suns reflection cast shadows upon the front of the (2) alignment apparatus the (11) photo sensors will be able to align the (1) mirror to its target. The (11) photo sensors will send its information to a microprocessor which will turn the (33) (34) stepping motors to align the (1) mirror. The (12) photo sensor used to check if the (1) mirror is aligned with the (2) alignment apparatus, is placed in a (20) cylinder at the front of the (2) alignment apparatus. When the reflection of the sun off the (1) mirror is in perfect alignment with the (2) alignment apparatus, the (12) photo sensor will not be shaded by the (20) cylinder, it will be in the sun beam. This will indicate that the (1) mirror is in alignment with the (2) alignment apparatus. When the (12) photo sensor is not in the sun beam, this information will be used to indicate that the (1) mirror is not lining up correctly.

The (12) photo sensor used to check if the (1) mirror is aligned with the (2) alignment apparatus, is placed in a (20) cylinder at the front of the (2) alignment apparatus. When the reflection of the sun off the (1) mirror is in perfect alignment with the (2) alignment apparatus, the (12) photo sensor will not be shaded by the (20) cylinder, it will be in the sun beam. This will indicate that the (1) mirror is in alignment with the (2) alignment apparatus. When the (12) photo sensor is not in the sun beam, this information will be used to indicate that the (1) mirror is not lining up correctly. A (14) light will light to indicate misalignment. Also the microprocessor can tilt the (1) mirror in a way to indicate that the (1) mirror is not lining up, so it can be identified as malfunctioning.

The (13) photo sensor used to check if the (2) alignment apparatus is aligned with the (3) target is placed in a (21) cylinder, when the reflection of the (3) target is in perfect alignment with the (2) alignment apparatus, the (21) photo sensor will not be shaded by the (21) cylinder. When the sun is shining the (3) target's radiant energy will be stronger then the (3) target's background, the background will typically be the sky. In a field of heliostats all pointing at the same (3) target, the (3) target will shine brightly. If the (2) alignment apparatus is not in line with the (1) target the (13) photo sensor will sense this, and indicate by lighting the (15) light.

If the (2) alignment apparatus is not lined up with the (3) target the (2) alignment apparatus will be able to realign its self back inline with the (3) target. This will be able to be done with two (18) (19) small motors mounted in the (22) pedestal of the (2) alignment apparatus. The (13) photo sensor will indicate to a microprocessor that the (2) alignment apparatus is misaligned. The microprocessor will control the two (18) (19) small motors in the (22) pedestal, moving the (2) alignment apparatus to find the (3) target and then centering the (2) alignment apparatus to the (3) target. On the rear of the (2) alignment apparatus a (16) laser will be mounted for initial installation and maintenance. This (16) laser will be used to adjust the (2) alignment apparatus to point at the (3) target, once the (2) alignment apparatus is aligned the (16) laser can be removed.

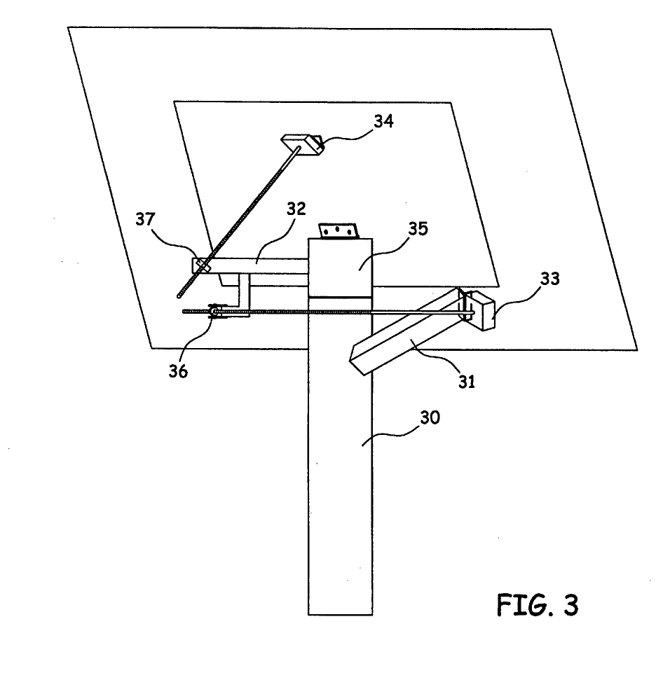

FIG. 3 is a view of the pan and tilt assembly. On the stationary part of the (30) pedestal a (31) control arm will be mounted, this (31) control arm will be used to mount the (33) panning stepping motor. On top of the stationary part of the (30) pedestal will set the (35) panning portion of the pedestal. On the (35) panning portion of the pedestal a (32) second control arm will be mounted. This (32) second control arm will be used to pivotally mount the (36) (37) nuts of both the (33) panning and (34) tilting stepping motors.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

1. A heliostat assembly comprising:
a heliostat mirror;
first and second control arms connected to the mirror for aligning the mirror relative to a target; and
first and second linear actuators operatively connected to the first and second control arms, respectively, for aligning the mirror relative to a target.

2. The heliostat assembly of claim 1 wherein the first control arm provides panning of the mirror and second control arm provides tilting of mirror.

3. The heliostat assembly of claim 1 further comprising means to control the linear actuators.

4. The heliostat assembly of claim 3 wherein the means to control the linear actuators is a feedback control loop circuit.

5. A method for aligning a heliostat mirror to its target comprising the step of:
moving the mirror in a panning motion with a linear actuator.

6. The heliostat assembly of claim 1 wherein the first and second control arm actuators include a threaded nut pivotally connected to the first and second control arms, respectively.

7. An alignment assembly for use with a heliostat, the alignment assembly comprising:
(a) means to detect the light from a target
(b) a circuit to determine misalignment of the assembly with respect to the target; and
(c) means for realigning the alignment assembly with respect to the target.

8. The alignment assembly of claim 7 further comprising a means to indicate misalignment.

9. The alignment assembly of claim 8 wherein said means includes at least one of an audible and a visible indicator.

10. In combination, a heliostat assembly and an alignment assembly;
the heliostat assembly comprising:
a heliostat mirror; and
at least one actuator for aligning the mirror relative to a target;
the alignment assembly comprising:
a photosensor to detect light from a target; and
at least one actuator for aligning the alignment assembly relative to the target.

11. A method for aligning a heliostat mirror to its target comprising the steps of:
sensing the light reflected off the target using a photo sensor mounted to an alignment apparatus; and
realigning the alignment apparatus with the target in response to the signals from the photosensor.
